(19) United States
(12) Patent Application Publication
(10) Pub. No.: US 2026/0366862 A1
(43) Pub. Date: Nov. 19, 2026

(54) SYSTEM AND METHOD FOR ALIGNMENT OF A MEASUREMENT HEAD WITH A SUBSTRATE

(71) Applicant: Thermo Fisher Scientific Messtechnik GmbH, Erlangen (DE)

(72) Inventor: Alexander Britting, Weißenohe (DE)

(21) Appl. No.: 19/673,491

(22) Filed: May 11, 2026

Related U.S. Application Data
(60) Provisional application No. 63/805,032, filed on May 13, 2025.

(51) Int. Cl. G01B 11/06

(52) U.S. Cl. CPC G01B 11/0616

(57) ABSTRACT

A first aspect of the invention provides a system for alignment of a measurement head with a substrate, the measurement head comprising a radiation source, configured to emit a first radiation beam; and a segmented chamber comprising a plurality of segments each having an inner channel and an outer channel, wherein the inner channel and the outer channel of each segment each comprise a radiation detector configured to generate a signal value responsive to radiation produced from interaction of the first radiation beam with the substrate; and a processor configured to: determine a ratio value using the signal from the inner channel and the signal value from the outer channel for each of the segments; determine a distance value for each of the segments using the ratio values; determine an orientation of the measurement head relative to the substrate using the distance values; and store the orientation.

### TECHNICAL FIELD

This disclosure is in the field of gauges for measuring material thickness and, more particularly, is directed to a system and method for aligning a measurement head or an arrangement of detectors disposed in compartments with a substrate.

### BACKGROUND

Thickness gauges can be used in a variety of industrial applications, such as for example, high precision measurement of material and/or coating thickness.

Thickness gauges typically comprise a measurement head with a radiation source and one or more detectors, a measurement portion arranged to receive a material to be measured. The system is arranged such that radiation is incident upon the one or more radiation detectors after interaction with a substrate in the measurement portion (e.g. a material to be measured, roller, planar surface, etc.). The interaction may be one or more of absorption, transmission, and reflection. The measurement relies upon determining the strength of the radiation after the interaction, as detected by the one or more radiation detectors.

System alignment of thickness gauging systems is crucial for system accuracy and gauge capability. Measurements have proven, that the pass line distance between the detectors (e.g. configured in a single measurement head or as an arrangement of separate compartments) and the substrate has to be maintained within a strict range in order to limit the increase of the overall noise for the measurements. Importantly, angle variation and scanner displacements must be taken into account. For example, alignment errors generally result in measurement errors during scanning.

Therefore, a need therefore exists for systems and methods for detecting and characterizing alignment errors associated with the configuration of detectors associated with a measurement head or an arrangement of separate compartments in thickness gauging systems.

### SUMMARY

Systems, methods, and products to address these and other needs are described herein with respect to illustrative, non-limiting, implementations. Various alternatives, modifications and equivalents are possible.

A first aspect of the invention provides a system for alignment of a measurement head with a substrate, the measurement head comprising a radiation source, configured to emit a first radiation beam; and a segmented chamber comprising a plurality of segments each having an inner channel and an outer channel, wherein the inner channel and the outer channel of each segment each comprise a radiation detector configured to generate a signal value responsive to radiation produced from interaction of the first radiation beam with the substrate; and a processor configured to: determine a ratio value using the signal from the inner channel and the signal value from the outer channel for each of the segments; determine a distance value for each of the segments using the ratio values; determine an orientation of the measurement head relative to the substrate using the distance values; and store the orientation.

The first radiation beam may be X-ray radiation. The first radiation beam may be gamma ray radiation. The first radiation beam may be beta radiation.

The radiation produced from interaction of the first radiation beam with the substrate may comprise reflected radiation. The radiation produced from interaction of the first radiation beam with the substrate may comprise fluorescent radiation. The radiation produced from interaction of the first radiation beam with the substrate may comprise scattered radiation. The radiation produced from interaction of the first radiation beam with the substrate may comprise phosphorescent radiation.

The inner and outer channels for each segment may be concentrically arranged around the radiation source.

The segmented chamber may comprise four segments. The four segments may be arranged in four quadrants with a substantially 90° orientation.

The processor may determine a ratio value of the signal from the inner channel and the signal from the outer channel for 3 of the segments. The ratio value may depend on a distance between the measurement head and the substrate.

The signal value may comprise an intensity value.

The processor may be further configured to normalize the signals from the inner channel and outer channel of the segments using a reference distance between the measurement head and the substrate.

The distance value for each of the segments may comprise a distance between the measurement head and the substrate.

A second aspect of the invention provides a method for alignment of a measurement head with a substrate that comprises determining a ratio value using a signal value from an inner channel and a signal value from an outer channel for each of a plurality of segments of a segmented chamber of a measurement head, wherein the signal values are representative of radiation produced from interaction of a first radiation beam with a substrate; determining a distance value for each of the segments using the ratio values; determining an orientation of the measurement head relative to the substrate using the distance values; and storing the orientation.

The first radiation beam may be X-ray radiation. The first radiation beam may be gamma ray radiation. The first radiation beam may be beta radiation.

The radiation produced from interaction of the first radiation beam with the substrate may comprise reflected radiation. The radiation produced from interaction of the first radiation beam with the substrate may comprise fluorescent radiation. The radiation produced from interaction of the first radiation beam with the substrate may comprise scattered radiation. The radiation produced from interaction of the first radiation beam with the substrate may comprise phosphorescent radiation.

The inner and outer channels for each segment may be concentrically arranged around the radiation source.

The segmented chamber may comprise four segments. The four segments may be arranged in four quadrants with a substantially 90° orientation.

The method may determine a ratio value of the signal from the inner channel and the signal from the outer channel for 3 of the segments. The ratio value may depend on a distance between the measurement head and the substrate.

The signal value may comprise an intensity value.

The method may further normalize the signals from the inner channel and outer channel of the segments using a reference distance between the measurement head and the substrate.

The distance value for each of the segments may comprise a distance between the measurement head and the substrate.

A third aspect of the invention provides a system for alignment of an arrangement of a plurality of compartments with a substrate comprising: a radiation source, configured to emit a first radiation beam; and an arrangement of a plurality of compartments each having an inner channel and an outer channel, wherein the inner channel and the outer channel of each chamber each comprise a radiation detector configured to generate a signal value responsive to radiation produced from interaction of the first radiation beam with the substrate; and a processor configured to: determine a ratio value using the signal from the inner channel and the signal value from the outer channel for each of the compartments; determine a distance value for each of the compartments using the ratio values; determine an orientation of the arrangement of the plurality of compartments relative to the substrate using the distance values; and store the orientation.

The first radiation beam may be X-ray radiation and/or gamma ray radiation and/or beta radiation.

The radiation produced from interaction of the first radiation beam with the substrate may be reflected radiation, fluorescent radiation, scattered radiation, or phosphorescent radiation.

The inner and outer channels for each compartment are concentrically arranged around the radiation source.

The processor determines a ratio value of the signal from the inner channel and the signal from the outer channel for 3 of the compartments.

The ratio value depends on a distance between the arrangement of the plurality of compartments and the substrate.

The signal value may be an intensity value.

The processor may be further configured to normalize the signals from the inner channel and outer channel of the compartments using a reference distance between the arrangement of the plurality of compartments and the substrate.

The distance value for each of the chambers may be a distance between the arrangement of the plurality of compartments and the substrate.

A fourth aspect of the invention provides a method for alignment of an arrangement of a plurality of compartments with a substrate comprising: determining a ratio value using a signal value from an inner channel and a signal value from an outer channel for each of a plurality of compartments of an arrangement of the plurality of compartments, wherein the signal values are representative of radiation produced from interaction of a first radiation beam with a substrate; determining a distance value for each of the compartments using the ratio values; determining an orientation of the arrangement of the plurality of compartments relative to the substrate using the distance values; and storing the orientation.

The inner channel and the outer channel for each compartments may be concentrically arranged around a radiation source.

The method may determine the ratio value for 3 of the compartments.

The ratio value may depend on a distance between the arrangement of the plurality of compartments and the substrate.

The signal value may be an intensity value.

The method may normalize the signals from the inner channel and outer channel of the compartments using a reference distance between the arrangement of the plurality of compartments and the substrate.

The distance value for each of the chambers may be a distance between the arrangement of the plurality of compartments and the substrate.

### BRIEF DESCRIPTION OF THE DRAWINGS

The above and further features will be more clearly appreciated from the following detailed description when taken in conjunction with the accompanying drawings. In the drawings, like reference numerals indicate like structures, elements, or method steps and the leftmost digit of a reference numeral indicates the number of the figure in which the references element first appears (for example, element 105 appears first in FIG. 1). All of these conventions, however, are intended to be typical or illustrative, rather than limiting.

FIG. 1 shows a cross-sectional schematic of a gauge with a measurement head according to the disclosure.

FIG. 2 shows a cross-sectional schematic of the measurement head of FIG. 1 with a radiation source and segmented chamber according to the disclosure.

FIG. 3 shows a bottom plan schematic of the segmented chamber FIG. 2 with individual segments each having an inner channel and an outer channel according to the disclosure.

FIGS. 4A and 4B show ratios inner chamber to outer chamber values from the individual segments of FIG. 3 according to the disclosure.

FIG. 5 shows a cross-sectional view of an exemplary radiation spot produced by the measurement head of FIGS. 1 and 2 according to the disclosure.

FIG. 6 show a method for alignment of a measurement head with a substrate according to the disclosure.

FIGS. 7A and 7B shows the calculated CD and MD angles according to the disclosure.

FIG. 8 shows the calculated distance variation using the CD and MD angles of FIGS. 7A and 7B according to the disclosure.

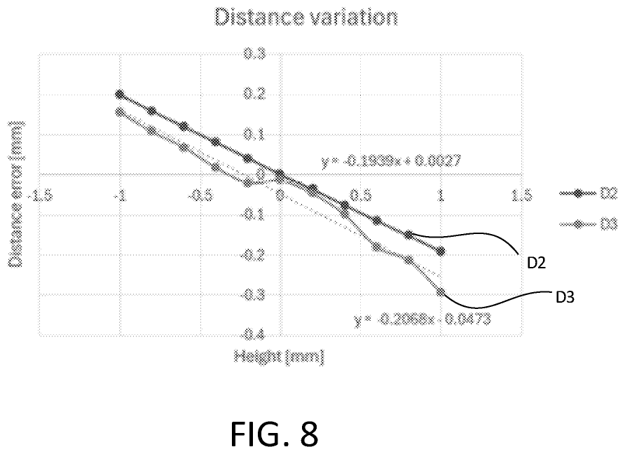

### DETAILED DESCRIPTION

As will be described in greater detail below, aspects of the described invention include a system and method that characterizes the degree of alignment between a arrangement of detectors (e.g. configured in a single measurement head or as an arrangement of separate compartments) and a substrate in order to minimize errors introduced into the data from scanning a substrate. More specifically, the correct position of measurement head is substantially normal to a plane of the substrate.

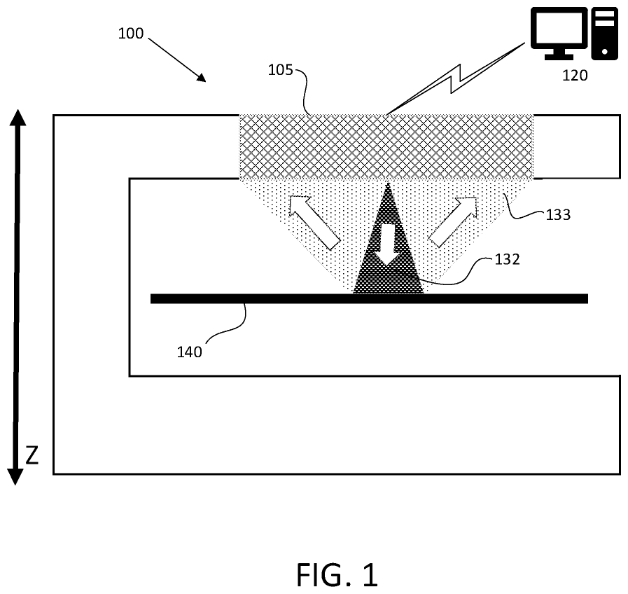

FIG. 1 provides an illustrative example of a gauge 100 that includes a measurement head 105 configured to measure radiation 133 (e.g. backscattered, fluorescent, scattered, or phosphorescent radiation) from a substrate 140 in response to radiation beam 132 according to the disclosure. Substrate 140 may include any material known in the art typically subjected to gauging applications for measurements of basis weight, thickness, elemental and/or molecular composition and/or distribution, etc. For example, substrate 140 may include a sheet or web of a metal, elastomer, organic, or plastic, or other material known in the art. Further substrate 140 may include coated substrates where the measurements may distinguish between substrate and coating characteristics. Substrate 140 may also include a roller, or planar surface incorporated into the configuration of gauge 100.

FIG. 1 also illustrates a network connection between computer 120 and gauge 100 and/or measurement head 105, however it will be appreciated that FIG. 1 is intended to be exemplary and additional or fewer network connections may be included. Further, the network connection between the elements may include “direct” wired or wireless data transmission (e.g. as represented by the lightning bolt) as well as “indirect” communication via other devices (e.g. switches, routers, controllers, computers, etc.) and therefore the example of FIG. 1 should not be considered as limiting.

Computer 120 may include any type of computing platform such as a workstation, a personal computer, a tablet, a “smart phone”, one or more servers, compute cluster (local or remote), or any other present or future computer or cluster of computers. Computers typically include known components such as one or more processors, an operating system, system memory, memory storage devices (e.g. sometimes referred to as a non-transitory computer-readable medium), input-output controllers, input-output devices, and display devices. It will also be appreciated that more than one implementation of computer 120 may be used to carry out various operations in different embodiments, and thus the representation of computer 120 in FIG. 1 should not be considered as limiting.

In some embodiments, computer 120 may employ a computer program product comprising a computer usable medium having control logic (e.g. computer software program, including program code) stored therein. The control logic, when executed by a processor, causes the processor to perform some or all of the functions described herein. In other embodiments, some functions are implemented primarily in hardware using, for example, a hardware state machine. Implementation of the hardware state machine so as to perform the functions described herein will be apparent to those skilled in the relevant arts. Also in the same or other embodiments, computer 120 may employ an internet client that may include specialized software applications enabled to access remote information via a network. A network may include one or more of the many types of networks well known to those of ordinary skill in the art. For example, a network may include a local or wide area network that may employ what is commonly referred to as a TCP/IP protocol suite to communicate. A network may include a worldwide system of interconnected computer networks that is commonly referred to as the internet, or could also include various intranet architectures. Those of ordinary skill in the related art will also appreciate that some users in networked environments may prefer to employ what are generally referred to as “firewalls” (also sometimes referred to as Packet Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

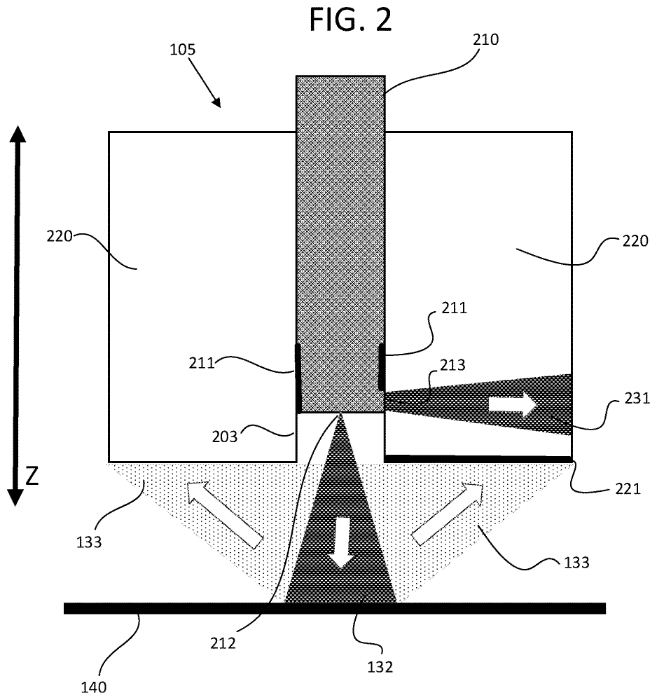

FIG. 2 provides an illustrative example of the measurement head 105 that comprises a radiation source 210. The radiation source 210 emits radiation. The radiation source 210 may generate X-ray radiation, gamma radiation, beta radiation, or any other suitable radiation as may be envisaged by the skilled person and as known in the art. For example, radiation source 210 may include an x-ray tube or HV-generator that may produce spikes, arcs, or other transients.

The radiation source 210 further comprises a shutter 211. Some implementations of measurement head 105 may also include an additional shutter (not shown), typically employed for safety reasons, the shutter positioned to block radiation beam 132 from exiting measurement head 105 (e.g. positioned between radiation source 210 and an exit aperture of measurement head 105). The radiation source 210 may be substantially cylindrical in diameter or other shape that corresponds to the dimensions of an internal channel of measurement head 105. The shutter 211 may be substantially toroidal, enclosing the end portion of radiation source 210. The shutter 211 may comprise material which absorbs the radiation produced by radiation source 210. For example, the shutter 111 may comprise lead, tungsten (alloy), or copper/steel (e.g. in case of lower energies, or carbon hydrogenes (e.g. in case of Beta rays).

The shutter 211 further comprises at least two apertures: a primary aperture 212 and a reference aperture 213, each configured to transmit the radiation produced by radiation source 210. The apertures comprise openings that may in some applications include windows made of a material transparent to the radiation produced by radiation source 210. Reference radiation beam 231 from the radiation produced by radiation source 210 is formed by reference aperture 213. Primary radiation beam 132 from the radiation produced by radiation source 210 is formed by primary aperture 212.

In a typical application, the measurement head 105 is integrated into a gauge system 100 that comprises a measurement portion configured to accept a substrate 140. The measurement head 105 in the gauge system 100 is arranged such that the radiation of the primary radiation beam 132 impinges upon the substrate 140 when it is in the measurement portion. In some applications the path of primary radiation beam 132 is substantially parallel to a first axis Z. After impinging on the substrate 140, the radiation of primary radiation beam 132 interacts with substrate 140 generating substrate radiation 133. In the example of FIG. 2, substrate radiation 133 is representative of the elemental and/or molecular composition of substrate 140 and may comprise backscattered, fluorescent, scattered, phosphorescent radiation, or radiation transmitted through substrate 140 (e.g. reflected from another substrate underneath substrate 140 back towards measurement head 105). The radiation of substrate radiation 133 may accordingly be of the same type or frequency as primary radiation beam 132, or may be of a different type or frequency, or may be of a combination of types or frequencies. The path of substrate radiation 133 is substantially antiparallel to primary radiation beam 132 along first axis Z (e.g. a path from substrate 140 to measurement head 105).

As illustrated in FIG. 2, the measurement head 105 comprises a segmented detection chamber 220. It will, however, be appreciated that an arrangement of independent compartments (e.g. not physically connected) can be implemented in the same manner as segmented detection chamber 220 and is considered within the scope of the invention. Segmented detection chamber 220 may be a segmented ion chamber. The segmented detection chamber 220 has a channel 203 through its length along first axis Z, which may be substantially cylindrical or other geometry known in the related art. In the described embodiment the segmented detection chamber 220 is substantially toroidal but other suitable shapes are contemplated herein. The segmented detection chamber 220 has a bottom surface substantially normal to the first axis Z and facing the measurement portion with substrate 140. The channel 203 of the segmented detection chamber 220 has an inner surface and the radiation source 210 is positioned within the channel 203.

In configurations where an arrangement of compartments is implemented, the arrangement comprises a central area analogous to channel 203 (e.g. with an implementation of radiation source 210 positioned as described above).

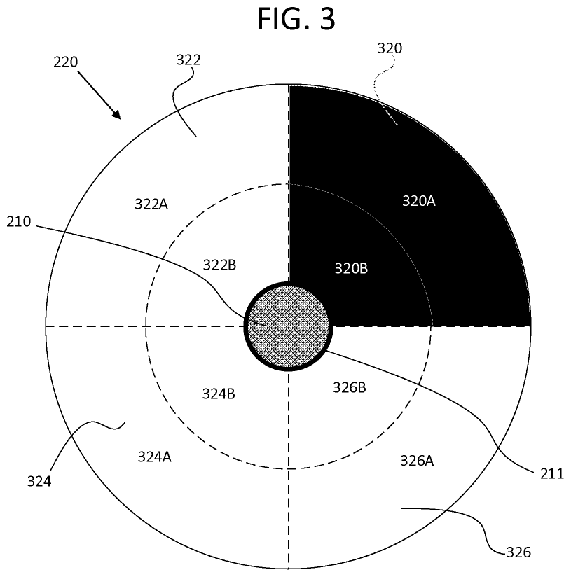

FIG. 3 shows a plan view of the bottom surface of the segmented detection chamber 220, with four segments (320, 322, 324, and 326) arranged in quadrants with a substantially 90° orientation relative to each other. It will, however, be appreciated that segmented detection chamber 220 may have a greater or lower number of segments, and thus the illustration of FIG. 3 should not be considered as limiting. As shown in FIGS. 2 and 3, the segmented detection chamber 220 further comprises a radiation shield 221. The radiation shield 221 may be attached to the bottom surface and or wall surfaces of one or more individual segments of the segmented detection chamber 220. The radiation shield 221 may be constructed of shielding material as described above with regard to shutter 211 (e.g. lead, tungsten (alloy), or copper/steel (e.g. in case of lower energies, or carbon hydrogenes (e.g. in case of Beta rays)). Although FIG. 3 shows the radiation shield 221 covering a single segment (e.g. segment 320) of the bottom surface of the segmented detection chamber 220 (also illustrated in FIG. 2), other proportions are contemplated herein. The radiation shield 221 may cover any suitable number of segments to cover a desired area of the bottom surface of the detection chamber 220. However, an area of the bottom surface of the detection chamber 220 remains uncovered by the radiation shield 221 to allow substrate radiation 133 to transmit past the bottom surface and into one or more of the individual segments.

As described above, in configurations where an arrangement of compartments is implemented, each of the compartments comprises a bottom surface analogous to that described for segmented detection chamber 220 and one or more of the compartments may include radiation shield 221.

The measurement head 105 is arranged such that the substrate radiation 133 impinges upon the bottom surface of the segmented detection chamber 220 and the reference radiation beam 231 impinges upon the inner surface of one or more individual segments of the segmented detection chamber 220 (e.g. chamber 320A and/or 320B). The radiation which impinges upon the individual segments of the segmented detection chamber 120 is measured by detectors within the individual segments that generate a voltage, the magnitude of which is related to the intensity of the radiation. As shown in the example of FIG. 3, the segments of the segmented detection chamber 220 are subdivided into individual chambers that may be separated by walls and arranged as an inner chamber (e.g. chamber 320B adjacent to source 210) and an outer chamber. For example, segment 320 comprises outer chamber 320A and inner chamber 320B; segment 322 comprises outer chamber 322A and inner chamber 320B; segment 324 comprises outer chamber 324A and inner chamber 320B; and segment 326 comprises outer chamber 326A and inner chamber 320B. Although FIG. 3 depicts two chambers per segment, it is contemplated herein that there may be three, four, or any higher number of chambers each having a radiation detector, but not less than two. Each radiation detector may produce a separate measurement voltage, Vⱼ(t) where j is A for chamber 320A, B for radiation detector in chamber 320B, and so on, related to the intensity of radiation incident upon that radiation detector.

The edges of the radiation shield 121 may be aligned with boundaries between chamber segments, as shown in FIG. 3. Thus, radiation from substrate radiation beam 133 is heavily attenuated for certain segments and chambers, for example chambers 320A and 320B. Reference aperture 213 may be arranged to direct reference beam 231 towards the chambers 320A, 320B. These may thus be referred to as reference chamber segments. The measurement voltages of the reference detectors, for example, V_{A}(t) and V_{B}(t) or, more generally, Vᵣ(t), may be referred to as reference voltages. The measurement voltages of the non-reference detectors (also referred to herein as incident detectors), for example, V_{F}(t) and V_{G}(t) or, more generally, Vᵢ(t), may be referred to as incident voltages. As described herein, the chambers 322A, 322B of segment 322, chambers 324A, 324B of segment 324, and chambers 326A, 326B of segment 326 are used for measurement calculations.

Further, in configurations where an arrangement of compartments is implemented, each of the independent compartments may be physically separated from one another, but share a positional arrangement and configuration of radiation shield 121 analogous to that described above for the segments 320, 322, 324, and 326.

According to the disclosure, for measurement calculations used for alignment of measurement head 105 or an arrangement of compartments, a processor of computer 120 may calculate a ratio of inner and outer channel measurement for each segment or compartment. The number of segments, compartments, and/or channels used for alignment may also depend on the product and/or measurement type. For example, there may be an additional dependency on product thickness or coating weight associated with substrate 140. More specifically, it may be important for measurements using a fluorescence measurement, like for zinc coated steel looking at the iron fluorescence.

In the described aspects the processor may calculate ratio values using the following equation:

$${R}_{i} ( d ) = \frac{\frac{{U}_{i} ( d )}{{U}_{i + k} ( d )}}{\frac{{U}_{i} ( {d}_{0} )}{{U}_{i + k} ( {d}_{0} )}} \qquad ( 1 )$$

With k>=3 (e.g. corresponding to the number of inner and out channels utilized), and i being equal to voltages from segments 322, 324, and 326 (Segment 320 is used as a reference). Uᵢ is the offset corrected voltage of the raw voltages Vᵢ, i.e. Uᵢ=Vᵢ−V_{i,shutter closed}. The processor of computer 120 may then normalize the calculated ratios by using a reference distance do, to remove the intensity variations between the different segments.

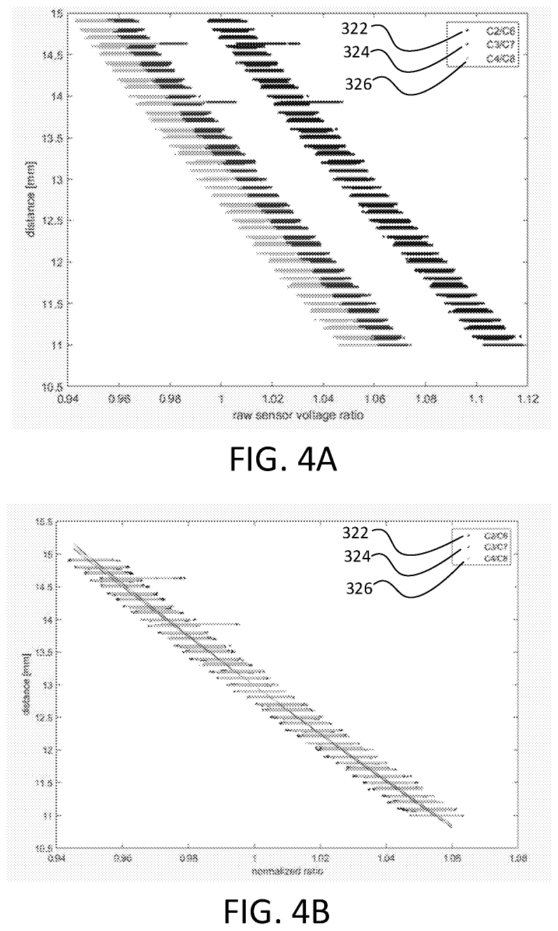

FIGS. 4A and 4B provides illustrative examples that demonstrate the relationship of the distance between measurement head 105 and substrate 140, to the calculated ratio of inner and outer channel measurement for each of segments 322, 324, and 326. More specifically, FIG. 4A illustrates the distance dependent values of the calculated ratios before normalization that demonstrates variation in the values from segments 322, 324, and 326, and FIG. 4B illustrates the distance dependent values of the calculated ratios after normalization that demonstrate substantially similar values from segments 322, 324, and 326.

Subsequently, the processor of computer 120 may utilize individual fit functions to further improves the accuracy. Using an n-dimensional polynomial provides the measured distance for each segment. For example, a distance value may be calculated as a second order polynomial for each segment using the following equation:

$${d}_{radio , i} = {\sum }_{k = 0}^{2} {a}_{i , k} * {R}_{i}^{k}$$

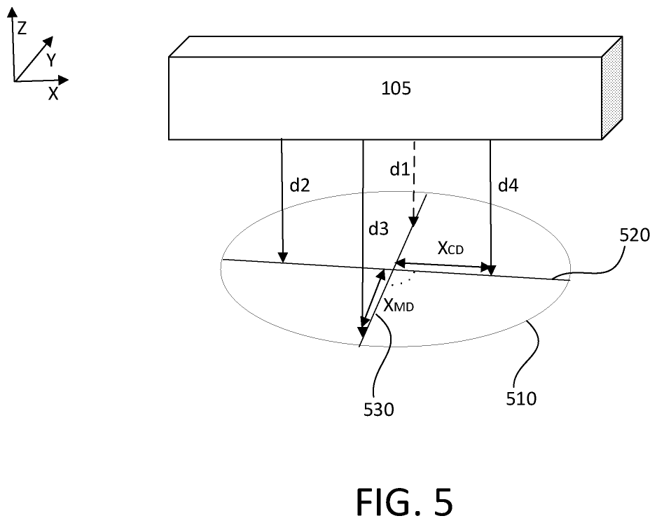

FIG. 5 provides an illustrative example of a measurement spot 510 produced from measurement head 105 (e.g. area of radiation exposure on substrate 140) with a center point at the intersection of axis 520 and axis 530. In the example of FIG. 5, d2 is representative of the distance calculated for segment 322, d3 is representative of the distance calculated for segment 324, and d4 is representative of the distance calculated for segment 326 (d1 relates to segment 320, that may not be utilized in some aspects). By having three individual measured distances at different locations at the surface, it is possible to describe the surface mathematically. It will, however, be appreciated that using a different number of channels and/or a different orientation of measurement head 105 relative to substrate 140, will result in different geometrical dependencies. Therefore, the use of three measured distances should not be considered as limiting. The processor then utilizes the distance measurements to produce any 2 or more vectors spanning the area.

For example, the center position as well as X_{CD} and X_{MD} vector positions may be calculated using the following equations:

$$Center position : {\vec{M}}_{Center} = ( \begin{matrix}0 \\ 0 \\ - ( {d}_{radio , 2} + {d}_{radio , 4} ) / 2\end{matrix} )$$

$$Vector from center position to measurement position of d 4 : {\vec{V}}_{CD} = ( \begin{matrix}{x}_{CD} \\ 0 \\ ( {d}_{radio , 2} - {d}_{radio , 4} ) / 2\end{matrix} )$$

$$Vector from center position to measurement position of d 3 : {\vec{V}}_{MD} = ( \begin{matrix}0 \\ - {x}_{MD} \\ ( {d}_{radio , 2} + {d}_{radio , 4} ) / 2 - {d}_{radio , 3}\end{matrix} )$$

Where x_{CD} and x_{MD} are the effective distances between center position and measurement position. For a round spot, such as for example measurement spot 510, there is: x_{CD}=x_{MD}

[symbol] _{CD} and [symbol] _{MD} will now span a surface through the center position and we can calculate the normal. Vector of the source may be calculated using the following equation:

$${\vec{V}}_{norm} = {\vec{V}}_{MD} \times {\vec{V}}_{CD} ( \begin{matrix}- {x}_{MD} * ( {d}_{radio , 2} - {d}_{radio , 4} ) / 2 \\ {x}_{CD} * ( ( {d}_{radio , 2} + {d}_{radio , 4} ) / 2 - {d}_{radio , 3} ) \\ {x}_{MD} * {x}_{CD}\end{matrix} ) = ( \begin{matrix}{y}_{n orm , x} \\ {y}_{n orm , y} \\ {y}_{n orm , z}\end{matrix} )$$

The processor of computer 120 may then calculate the relationship between substrate and the measurement head 105:

$${α}_{CD} = Arcsin ( \frac{{V}_{norm , x}}{\vert {\vec{V}}_{norm} \vert} )$$

$${α}_{MD} = Arcsin ( \frac{{V}_{norm , Y}}{\vert {\vec{V}}_{norm} \vert} )$$

$${d}_{radio , total} = ( {d}_{radio , 2} + {d}_{radio , 4} ) / 2$$

### DEFINITIONS

| | |
|---|---|
| Uᵢ | Background subtracted channel voltage of channel i |
| Rᵢ | Ratio of inner and outer channels normalized to a |
| | reference distance |
| a_{i, k} | k-th value of polynomial fit values of ratio i |
| X_{CD}, X_{MD} | Distance between center position and distance measured |
| | (d2, d3, and d4) |
| CD angle | Displacement angle in XZ plane |
| MD angle | Displacement angle in YZ plane |

According to the disclosure, implementation of an alignment measurement function substantially limits the time required for performing an adjustment to the alignment of measurement head 105, especially in the case of an exchange of the measurement head 105. For example, the alignment measurement function may only require a short time period for execution (<1 min). The alignment measurement function may also provide more desirable results when utilizing a particular position on substrate 140 where the material of substrate 140 comprises a material to be measured by thickness gauge 100 or a close surrogate. Continuing with the present example, the alignment measurement function may be invoked by a simple button and the system shall perform any actions and data storage in a fully automated manner.

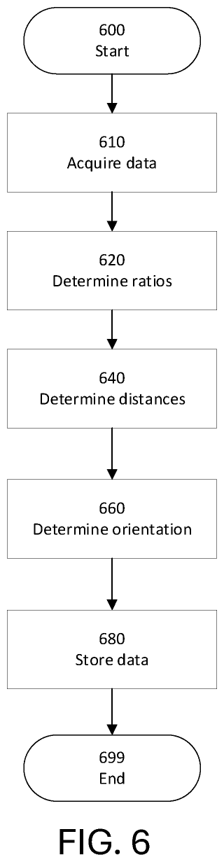

FIG. 6 provides an illustrative example of a method for measuring an alignment of measurement head 105 relative to substrate 140, beginning at the start 600, in step 610 a processor may acquire the voltage data for a plurality of segment as described herein. In step 620 the processor may determine the ratio of voltage values from the inner and outer channels of a plurality of the segment. In some cases, the processor may also normalize the values. Next, in step 640 the processor calculates a distance value for each of the segments using the ratio values, then in step 660 the processor determines an orientation of the measurement head relative to the substrate using the distance values. In step 680, the processor stores the orientation data. It will be appreciated that the processor may store some or all of the other data generated from the alignment measurement function. Also, the data may be utilized for making adjustments to the alignment of measurement head 105 such as, for example, by a technician or motorized control by computer 120.

### Example of Parameter Calculation of X_{MD} and X_{CD}

A plate of pure reference material was placed in a sample holder and measurement was performed for 11 to 15 mm in 0.2 mm steps. The holder was tilted in MD, CD and 45° orientation by underlying gauge blocks in 0.2 mm steps.

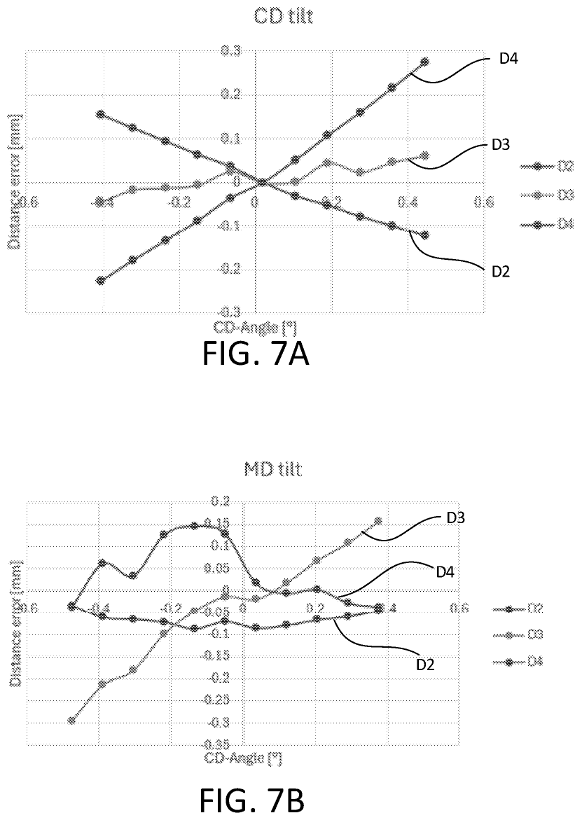

FIGS. 7A and 7B illustrate the results from the addition of a support that produced a positive angle at Segment 322 (positive CD angle results in a lower distance measured for d2, higher for d4) and an additional support at Segment 320 (positive MD angle results in higher distance measured at d3).

Based on the calculated angle relation, it is possible to determine the effective distance of the individual measurement locations by triangulation of the measured distance errors and comparing with the applied angle as illustrated in. Since the measurement head has a round spot, the average value is the fitted linear curve is taken to determine the effective distances of X_{MD} and X_{CD} to 28.05 mm as a fixed value for all measurement heads.

1. A system for alignment of a measurement head with a substrate comprising:
the measurement head comprising:
a radiation source, configured to emit a first radiation beam; and
a segmented chamber comprising a plurality of segments each having an inner channel and an outer channel, wherein the inner channel and the outer channel of each segment each comprise a radiation detector configured to generate a signal value responsive to radiation produced from interaction of the first radiation beam with the substrate; and
a processor configured to:
determine a ratio value using the signal from the inner channel and the signal value from the outer channel for each of the segments;
determine a distance value for each of the segments using the ratio values;
determine an orientation of the measurement head relative to the substrate using the distance values; and
store the orientation.

2. The system of claim 1, wherein:
the first radiation beam comprises X-ray radiation, or gamma ray radiation, or beta radiation.

3. The system of claim 1, wherein:
the radiation produced from interaction of the first radiation beam with the substrate comprises reflected radiation, fluorescent radiation, scattered radiation, or phosphorescent radiation.

4. The system of claim 1, wherein:
inner and outer channels for each segment are concentrically arranged around the radiation source.

5. The system of claim 1, wherein:
the segmented chamber comprises four segments.

6. The system of claim 5, wherein:
the four segments are arranged in four quadrants with a substantially 90° orientation.

7. The system of claim 1, wherein:
the processor determines a ratio value of the signal from the inner channel and the signal from the outer channel for 3 of the segments.

8. The system of claim 1, wherein:
the ratio value depends on a distance between the measurement head and the substrate.

9. The system of claim 1, wherein:
the signal value comprises an intensity value.

10. The system of claim 1, wherein:
the processor is further configured to normalize the signals from the inner channel and outer channel of the segments using a reference distance between the measurement head and the substrate.

11. The system of claim 1, wherein:
the distance value for each of the segments comprises a distance between the measurement head and the substrate.

12. A method for alignment of a measurement head with a substrate comprising:
determining a ratio value using a signal value from an inner channel and a signal value from an outer channel for each of a plurality of segments of a segmented chamber of a measurement head, wherein the signal values are representative of radiation produced from interaction of a first radiation beam with a substrate;
determining a distance value for each of the segments using the ratio values;
determining an orientation of the measurement head relative to the substrate using the distance values; and
storing the orientation.

13. The method of claim 12, wherein:
the first radiation beam comprises X-ray radiation and/or gamma ray radiation and/or beta radiation.

14. The method of claim 12, wherein:
the radiation produced from interaction of the first radiation beam with the substrate comprises reflected radiation, fluorescent radiation, scattered radiation, or phosphorescent radiation.

15. The method of claim 12, wherein:
the inner channel and the outer channel for each segment are concentrically arranged around a radiation source.

16. The method of claim 12, wherein:
the segmented chamber comprises four segments.

17. The method of claim 16, wherein:
the four segments are arranged in four quadrants with a substantially 90° orientation.

18. The method of claim 12, wherein:
determining the ratio value for 3 of the segments.

19. The method of claim 12, wherein:
the ratio value depends on a distance between the measurement head and the substrate.

20. The method of claim 12, wherein:
the signal value comprises an intensity value.

21. The method of claim 12, further comprising:
normalizing the signals from the inner channel and outer channel of the segments using a reference distance between the measurement head and the substrate.

22. The method of claim 12, wherein:
the distance value for each of the segments comprises a distance between the measurement head and the substrate.

23. A system for alignment of an arrangement of a plurality of compartments with a substrate comprising:
a radiation source, configured to emit a first radiation beam; and
an arrangement of a plurality of compartments each having an inner channel and an outer channel, wherein the inner channel and the outer channel of each compartments each comprise a radiation detector configured to generate a signal value responsive to radiation produced from interaction of the first radiation beam with the substrate; and
a processor configured to:
determine a ratio value using the signal from the inner channel and the signal value from the outer channel for each of the compartments;
determine a distance value for each of the compartments using the ratio values;
determine an orientation of the arrangement of the plurality of compartments relative to the substrate using the distance values; and
store the orientation.

24. The system of claim 23, wherein:
the first radiation beam comprises X-ray radiation, or gamma ray radiation, or beta radiation.

25. The system of claim 23, wherein:
the radiation produced from interaction of the first radiation beam with the substrate comprises reflected radiation, fluorescent radiation, scattered radiation, or phosphorescent radiation.

26. The system of claim 23, wherein:
the inner channel and the outer channel for each compartment are concentrically arranged around the radiation source.

27. The system of claim 23, wherein:
the processor determines a ratio value of the signal from the inner channel and the signal from the outer channel for 3 of the compartments.

28. The system of claim 23, wherein:
the ratio value depends on a distance between the arrangement of the plurality of compartments and the substrate.

29. The system of claim 23, wherein:
the signal value comprises an intensity value.

30. The system of claim 23, wherein:
the processor is further configured to normalize the signals from the inner channel and outer channel of the compartments using a reference distance between the arrangement of the plurality of compartments and the substrate.

31. The system of claim 23, wherein:
the distance value for each of the compartments comprises a distance between the arrangement of the plurality of compartments and the substrate.

32. A method for alignment of an arrangement of a plurality of compartments with a substrate comprising:
determining a ratio value using a signal value from an inner channel and a signal value from an outer channel for each of a plurality of compartments of an arrangement of the plurality of compartments, wherein the signal values are representative of radiation produced from interaction of a first radiation beam with a substrate;
determining a distance value for each of the compartments using the ratio values;
determining an orientation of the arrangement of the plurality of compartments relative to the substrate using the distance values; and
storing the orientation.

33. The method of claim 32, wherein:
the inner channel and the outer channel for each compartment are concentrically arranged around a radiation source.

34. The method of claim 32, wherein:
determining the ratio value for 3 of the compartments.

35. The method of claim 32, wherein:
the ratio value depends on a distance between the arrangement of the plurality of compartments and the substrate.

36. The method of claim 32, wherein:
the signal value comprises an intensity value.

37. The method of claim 32, further comprising:
normalizing the signals from the inner channel and outer channel of the compartments using a reference distance between the arrangement of the plurality of compartments and the substrate.

38. The method of claim 32, wherein:
the distance value for each of the compartments comprises a distance between the arrangement of the plurality of compartments and the substrate.
